(19) United States
(12) Patent Application Publication
(10) Pub. No.: US 2025/0304055 A1
(43) Pub. Date: Oct. 2, 2025

(54) PATH ESTIMATION DEVICE AND COLLISION DETERMINATION DEVICE

(71) Applicants: DENSO CORPORATION, Kariya-city, Aichi-pref. (JP); TOYOTA JIDOSHA KABUSHIKI KAISHA, Toyota-shi, Aichi-ken (JP); J-QuAD DYNAMICS Inc., Tokyo (JP)

(72) Inventors: Mikio OKUDA, Tokyo (JP); Yoichi ABE, Tokyo (JP); Kenichi SHIMIZU, Gotenba-shi (JP)

(21) Appl. No.: 19/089,816

(22) Filed: Mar. 25, 2025

(30) Foreign Application Priority Data
Mar. 28, 2024 (JP) 2024-052861

(51) Int. Cl. B60W 30/095

(52) U.S. Cl. CPC B60W 30/0956; B60W 2520/14; B60W 2540/18; B60W 2554/4041; B60W 2554/4045

(57) ABSTRACT

A path estimation device configured to estimate a travel path of a vehicle configured as a four-wheel steering vehicle is provided. The path estimation device includes an acquisition unit configured to acquire rear wheel steering information, which is information concerning a steering angle of a rear wheel of the vehicle, and an own vehicle path estimation unit configured to estimate the travel path by using a rate of change with time of the steering angle of the rear wheel specified using the rear wheel steering information.

### CROSS-REFERENCE TO RELATED APPLICATION

The present application is based on and claims the benefit of priority from earlier Japanese Patent Application No. 2024-52861 filed on Mar. 28, 2024, the description of which is incorporated herein by reference.

### BACKGROUND

### Technical Field

The present disclosure relates to a path estimation device and a collision determination device.

### Related Art

Conventionally, a technique has been known in which it is determined whether there is a possibility of a collision between an own vehicle and a target from a predicted travel path of the own vehicle and a travel path of the target around the own vehicle, and, when there is a possibility of a collision, braking operation is performed to decelerate the own vehicle, thereby suppressing the possibility of a collision.

### SUMMARY

An aspect of the present disclosure provides a path estimation device configured to estimate a travel path of a vehicle configured as a four-wheel steering vehicle. The path estimation device includes: an acquisition unit configured to acquire rear wheel steering information, which is information concerning a steering angle of a rear wheel of the vehicle; and an own vehicle path estimation unit configured to estimate the travel path by using a rate of change with time of the steering angle of the rear wheel specified using the rear wheel steering information.

### BRIEF DESCRIPTION OF THE DRAWINGS

In the accompanying drawings:

FIG. 1 is an explanatory drawing illustrating a schematic configuration of a vehicle control system of a present embodiment;

FIG. 2 is an explanatory drawing of an own vehicle presence area on an x-y plane in a two-dimensional coordinate system;

FIG. 3 is an explanatory drawing of a target presence area on an x-y plane in a two-dimensional coordinate system;

FIG. 4 is an explanatory drawing of an own vehicle solid and a target solid in a three-dimensional coordinate system;

FIG. 5 is an explanatory drawing illustrating a determination of a collision between an own vehicle and a target based on the own vehicle solid and the target solid;

FIG. 6 is a first flowchart illustrating a procedure of a collision determination process of the present embodiment; and

FIG. 7 is a second flowchart illustrating the procedure of the collision determination process of the present embodiment.

### DETAILED DESCRIPTION OF THE PREFERRED EMBODIMENTS

Conventionally, a technique has been known in which it is determined whether there is a possibility of a collision between an own vehicle and a target from a predicted travel path of the own vehicle and a travel path of the target around the own vehicle, and, when there is a possibility of a collision, braking operation is performed to decelerate the own vehicle, thereby suppressing the possibility of a collision (JP-A-2021-172144).

In JP-A-2021-172144, when a travel path of the own vehicle is estimated, a yaw rate of the own vehicle detected by a yaw rate sensor is used. The detected yaw rate includes a yaw rate of a revolution due to turning motion of the own vehicle and a yaw rate of a rotation due to yaw motion of the own vehicle. However, since a four-wheel steering vehicle also performs steering control of the rear wheels, compared with a two-wheel steering vehicle, influence of the yaw rate of the rotation is significant in the detected yaw rate. Hence, there is a problem that if the four-wheel steering vehicle estimates a travel path of the own vehicle using the unmodified detected yaw rate, accuracy in estimating a travel path is lowered. Such a problem is caused not only in travel path prediction for collision determination but also in various types of travel path prediction for vehicle control.

### a. First Embodiment

### a-1. System Configuration:

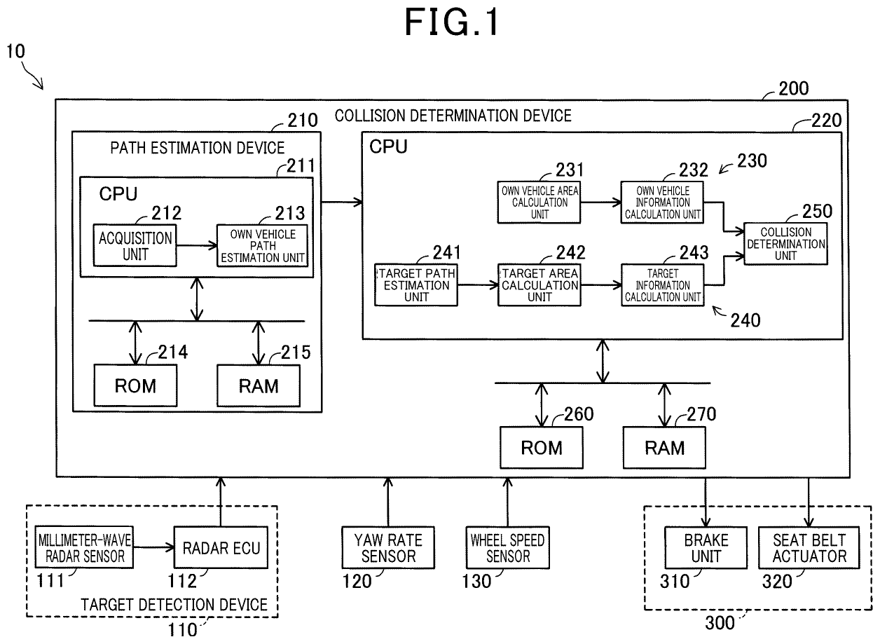

A vehicle control system 10 including a collision determination device 200 of the present embodiment is applied to a vehicle. The vehicle to which the vehicle control system 10 is applied may be configured to be able to be autonomously driven. The vehicle control system 10 illustrated in FIG. 1 includes a target detection device 110 and the collision determination device 200.

The target detection device 110 transmits millimeter waves and detects a location of a target TG around an own vehicle and a relative speed of the target with respect to an own vehicle based on reflected waves generated when the transmitted millimeter waves are reflected by the target TG. The target detection device 110 includes millimeter-wave radar sensors 111 and a radar ECU 112.

The millimeter-wave radar sensors 111 are respectively mounted to, for example, the front and the rear of the own vehicle, and radiate millimeter waves to a region around the own vehicle and receive reflected waves thereof. The millimeter-wave radar sensors 111 output reflected wave signals concerning the received reflected waves to the radar ECU 112.

The radar ECU 112 calculates a location of the target around the own vehicle and a relative speed of the target with respect to the own vehicle from the reflected wave signals output from the millimeter-wave radar sensors 111. The radar ECU 112 outputs the calculated location of the target and the calculated relative speed of the target with respect to the own vehicle to the collision determination device 200. The radar ECU 112 is configured by, for example, a computer including a CPU (Central Processing Unit), a ROM (Read Only Memory), a RAM (Random Access Memory), an input-output interface, and the like. It is noted that ECU is an abbreviation for “Electronic Control Unit”.

The collision determination device 200 is connected with a yaw rate sensor 120, a wheel speed sensor 130, and a collision suppression device 300. The yaw rate sensor 120 is mounted at, for example, the central position of the own vehicle and outputs a yaw rate signal corresponding to the rate of change of the amount of steering of the own vehicle to the collision determination device 200. The wheel speed sensor 130 is mounted to, for example, a wheel part of the vehicle and outputs a wheel speed signal corresponding to the wheel speed of the vehicle to the collision determination device 200.

The collision suppression device 300 suppresses a collision of a target with the own vehicle and includes, in the present embodiment, a brake unit 310 and a seat belt actuator 320.

The brake unit 310 controls braking caused by a brake actuator. Specifically, the brake unit 310 controls braking force of the brake actuator in accordance with a deceleration signal output from the collision determination device 200. Since the braking force of the brake actuator is controlled, the deceleration amount of the own vehicle is adjusted. In accordance with a start signal output from the collision determination device 200, the seat belt actuator 320 activates a winding unit of the seat belt to rewind and tension the seat belt.

The collision determination device 200 determines presence or absence of a possibility of a collision of a target with the own vehicle according to a location of the target and a relative speed of the target with respect to the own vehicle output from the target detection device 110. Specifically, the collision determination device 200 calculates an own vehicle solid, which is a solid indicating a movement of an own vehicle presence area on an estimated path of the own vehicle in a virtually formed three-dimensional coordinate system. In addition, the collision determination device 200 calculates a target solid, which is a solid indicating a movement of a presence area of the target on the estimated path of the target based on the location of the target and the relative speed of the target with respect to the own vehicle output from the target detection device 110 in the three-dimensional coordinate system. Then, based on presence or absence of intersection between the own vehicle solid and the target solid, the collision determination device 200 determines presence or absence of a possibility of a collision between the own vehicle and the target. In the following description, the location of the target and the relative speed of the target with respect to the own vehicle output from the target detection device 110 are also referred to as target information.

If determining that the target would collide with the own vehicle, and performing braking operation, the collision determination device 200 activates the collision suppression device 300 to cause the collision suppression device 300 to perform collision suppression control for the own vehicle. For example, the collision determination device 200 generates and outputs a deceleration signal to be output to the brake unit 310 and a start signal to be output to the seat belt actuator 320 to cause the collision suppression device 300 to perform the collision suppression control.

The collision determination device 200 is configured as a computer including a CPU 220, a ROM 260, and a RAM 270. In the present embodiment, the collision determination device 200 further includes a path estimation device 210. The path estimation device 210 uses a yaw rate detected by the yaw rate sensor 120 and an own vehicle speed detected by the wheel speed sensor 130 to calculate an estimated path of the own vehicle.

In the present embodiment, the path estimation device 210 is configured as a computer including a CPU 211, a ROM 214, and a RAM 150. The CPU 211 expands a program previously stored in the ROM 214, into the RAM 215, and executes the program, thereby functioning as an acquisition unit 212 and an own vehicle path estimation unit 213.

The acquisition unit 212 acquires a yaw rate of the own vehicle and an own vehicle speed. In the present embodiment, the acquisition unit 212 uses a yaw rate signal output from the yaw rate sensor 120 to calculate a yaw rate of the own vehicle and uses a wheel speed signal output from the wheel speed sensor 130 to calculate an own vehicle speed. In the following description, the yaw rate calculated using the yaw rate signal output from the yaw rate sensor 120 is also referred to as an uncorrected yaw rate.

In addition, when the own vehicle is configured as a four-wheel steering vehicle, in addition to the above, the acquisition unit 212 acquires rear wheel steering information. The four-wheel steering vehicle means a vehicle that can perform not only steering control of the front wheels of the vehicle but also steering control of the rear wheels. The rear wheel steering information means information concerning steering angles of the rear wheels of the own vehicle. In the present embodiment, the acquisition unit 212 acquires, as the rear wheel steering information, a control signal for instructing a rear wheel steering device, not shown, included in the own vehicle, about rear wheel steering angles. A history of the rear wheel steering angles indicated by the acquired control signal is stored in the ROM 214. It is noted that when a rear wheel steering angle sensor that calculates a rear wheel steering angle is provided to an own vehicle VM, the acquisition unit 212 may acquire a detection signal from the rear wheel steering angle sensor as the rear wheel steering information.

The own vehicle path estimation unit 213 uses the obtained yaw rate of the own vehicle and the obtained own vehicle speed to calculate an own vehicle estimated path PA1 indicating an estimated path of the own vehicle VM. In the present embodiment, the own vehicle path estimation unit 213 uses the yaw rate of the own vehicle and the own vehicle speed to calculate an estimated curve radius of the own vehicle. Then, the own vehicle path estimation unit 213 calculates, as the own vehicle estimated path PA1, a path on which the own vehicle travels along the calculated estimated curve radius. The own vehicle path estimation unit 213 outputs the calculated own vehicle estimated path PA1 to the CPU 220.

Path estimation by the own vehicle path estimation unit 213 of the present embodiment will be described more specifically. In the present embodiment, the own vehicle path estimation unit 213 performs path estimation by different methods between a case in which the own vehicle VM is configured as a two-wheel steering vehicle and a case in which the own vehicle VM is configured as a four-wheel steering vehicle. The uncorrected yaw rate described above includes a yaw rate of a revolution due to turning motion of the own vehicle and a yaw rate of a rotation due to yaw motion of the own vehicle. When the own vehicle VM is configured as a two-wheel steering vehicle, since only steering control of the front wheels is performed, the yaw motion is performed corresponding to the turning motion, and it can be assumed that the uncorrected yaw rate is equal to the yaw rate of the revolution. Hence, the own vehicle path estimation unit 213 can accurately calculate the estimated curve radius of the own vehicle by using the uncorrected yaw rate and can accurately calculate the own vehicle estimated path PA1 calculated based on the estimated curve radius.

In contrast, when the own vehicle VM is configured as a four-wheel steering vehicle, since not only the steering control of the front wheels but also the steering control of the rear wheels are performed, yaw motion is also performed independently of turning motion, whereby influence of the yaw rate of a rotation is significant. Hence, if the estimated curve radius is calculated using the uncorrected yaw rate, an error is produced in the estimated curve radius of the own vehicle VM, and an error is produced in the own vehicle estimated path PA1 calculated based on the estimated curve radius. Hence, when the own vehicle VM is configured as a four-wheel steering vehicle, the own vehicle path estimation unit 213 of the present embodiment calculates a corrected yaw rate and uses the calculated corrected yaw rate to calculate the estimated curve radius of the own vehicle VM. The corrected yaw rate means a yaw rate obtained by correcting the uncorrected yaw rate by a rate of change with time of the rear wheel steering angle. The own vehicle path estimation unit 213 uses a history of the rear wheel steering angles obtained as rear wheel steering information to specify the rate of change with time of the rear wheel steering angle. In the present embodiment, the own vehicle path estimation unit 213 performs the correction by subtracting the rate of change with time of the rear wheel steering angle from the uncorrected yaw rate. Subtracting the uncorrected yaw rate using the rate of change with time of the rear wheel steering angle, that is, the yaw rate of a rotation produced by the steering control of the rear wheels can exclude the yaw rate of the rotation produced by the steering control of the rear wheels from the corrected yaw rate. Calculating the estimated curve radius of the own vehicle using the corrected yaw rate calculated as described above can suppress an error of the estimated curve radius and can suppress an error of the own vehicle estimated path PA1 calculated based on the estimated curve radius.

The CPU 220 expands a program previously stored in the ROM 260, into the RAM 270 and executes the program to achieve the above collision determination. In the present embodiment, the CPU 220 functions as an own vehicle movement calculation unit 230, a target movement calculation unit 240, and a collision determination unit 250. In addition, the own vehicle movement calculation unit 230 is realized by an own vehicle area calculation unit 231 and an own vehicle information calculation unit 232. The target movement calculation unit 240 is realized by a target path estimation unit 241, a target area calculation unit 242, and a target information calculation unit 243.

As described later, the own vehicle movement calculation unit 230 calculates an own vehicle solid, which is a solid indicating a movement of the own vehicle presence area on an estimated path of the own vehicle in a virtually formed three-dimensional coordinate system. In addition, as described later, the target movement calculation unit 240 also calculates a target solid, which is a solid indicating a movement of a presence area of the target on the estimated path of the own vehicle determined from the location of the target and the relative speed of the target with respect to the own vehicle output from the target detection device 110 in the three-dimensional coordinate system.

The own vehicle area calculation unit 231 calculates an own vehicle presence area EA1 indicating an area in which the own vehicle is present at given time intervals on the own vehicle estimated path PA1 calculated by the path estimation device 210, on the X-Y plane of the two-dimensional coordinate system defined by a distance Y in the own vehicle traveling direction at the present time T0 and a distance X in the vehicle width direction. In the present embodiment, the own vehicle area calculation unit 231 calculates the own vehicle presence areas EA1 at respective locations on the own vehicle estimated path PA1 during a time period from the present time T0 (hereinafter, also referred to as the present T0) to estimated termination time TN.

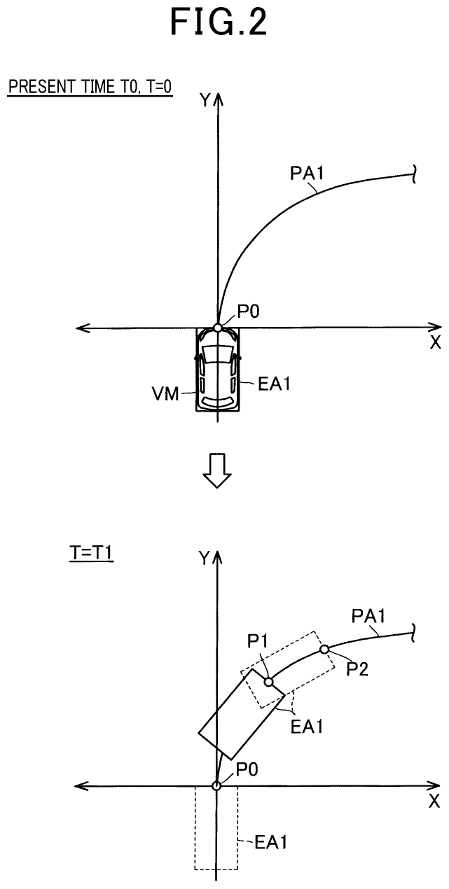

The upper part in FIG. 2 illustrates the own vehicle presence area EA1 calculated for the own vehicle VM at the present T0, that is, elapsed time T of 0. In the present embodiment, the own vehicle presence area EA1 is defined as a rectangular area including the whole outer periphery of the own vehicle VM viewed from above. The own vehicle area calculation unit 231 defines the rectangular area forming the own vehicle presence area EA1 in accordance with vehicle specifications indicating the size of the own vehicle. For example, the own vehicle presence area EA1 at the present T0 is defined so that the intersection (0, 0) between the X axis and the Y axis matches a reference position P0 of the own vehicle VM. In addition, the reference position P0 of the own vehicle VM is set so as to be the center in the vehicle width direction at the front of the own vehicle.

In the lower part in FIG. 2, a future own vehicle presence area EA1 at the time at which the elapsed time T has elapsed by only T1 from the present T0 is illustrated with respect to the own vehicle presence area EA1 at the present TO illustrated in the upper part in FIG. 2, as a comparison. It is noted that, in the lower part in FIG. 2, in order to simplify the description, the own vehicle presence area EA1 at the present T0 and the own vehicle presence area EA1 at the time at which the elapsed time T has elapsed by only T2 from the present TO (T2>T1) are illustrated with broken lines.

The own vehicle presence areas EA1 at the time at which only the elapsed time T1 has elapsed from the present TO indicates a presence area of the own vehicle after only the elapsed time T1 has elapsed from the own vehicle location at the present TO when the own vehicle VM travels along the own vehicle estimated path PA1. For example, the own vehicle area calculation unit 231 calculates a passing position at which only the elapsed time Tn (n is a value of 0 or larger and N or smaller) has elapsed from the reference position P0 of the own vehicle VM at the present T0 on the own vehicle estimated path PA1, from the own vehicle estimated path PA1 calculated at the own vehicle location at the present T0 and the own vehicle speed. Then, rectangular areas whose reference positions Pn are set to the respective passing positions are calculated as the future own vehicle presence areas EA1 at the time at which the elapsed time T has elapsed by only the elapsed time Tn from the present T0. In the present embodiment, the directions of the own vehicle presence areas EA1 at the respective elapsed times Tn are set to the directions of tangential lines of the own vehicle estimated path PA1 at the respective reference positions Pn.

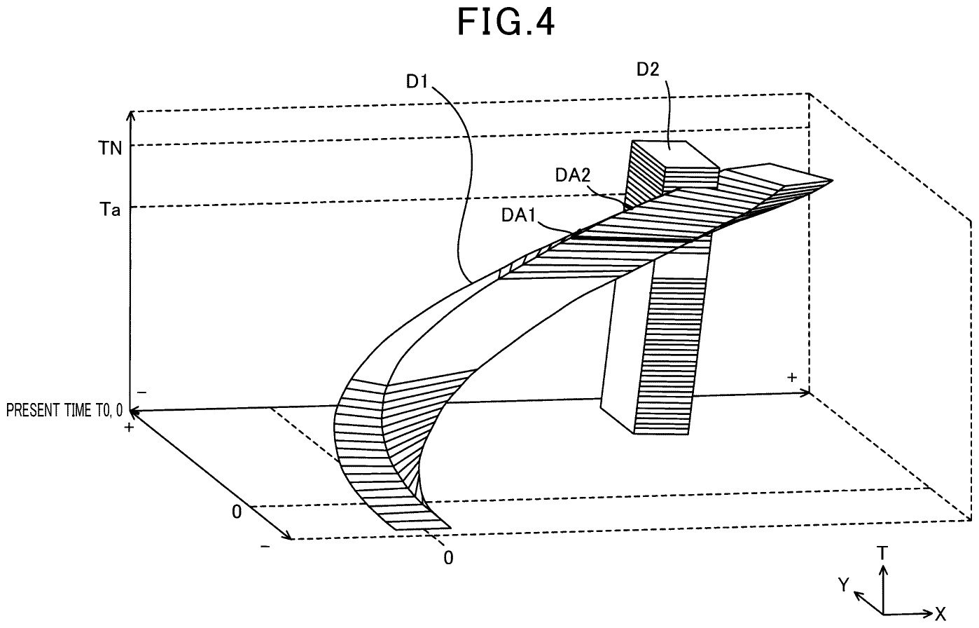

The own vehicle information calculation unit 232 calculates an own vehicle solid D1 indicating a movement of the own vehicle presence area EA1 by interpolating a plurality of own vehicle presence areas EA1 in the three-dimensional coordinate system defined by a distance Y in the own vehicle traveling direction, a distance X in the vehicle width direction, and the elapsed time T from the present T0. In the three-dimensional coordinate system illustrated in FIG. 4, the point (0, 0, 0) indicates the reference position P0 of the own vehicle at the present T0. In the three-dimensional coordinate system, the own vehicle solid D1 indicates a movement of the own vehicle presence area EA1 with the elapsed time T. In FIG. 4, the own vehicle solid D1 is calculated in the predicted time width from the present TO to the estimated termination time TN.

In the present embodiment, the own vehicle information calculation unit 232 converts the calculated plurality of own vehicle presence areas EA1 to information in the three-dimensional coordinate system. Then, in the three-dimensional coordinate system, linear interpolation is performed between four corners of the own vehicle presence areas EA1 adjacent to each other in the direction in which a T axis defining elapsed time extends, to calculate the own vehicle solid D1.

In the target movement calculation unit 240, the target path estimation unit 241 calculates a target estimated path PA2 indicating an estimated path of the target from target information detected by the target detection device 110. For example, the target path estimation unit 241 calculates a movement locus of the target from the change of a target location detected by the target detection device 110 and sets the travel path as the target estimated path PA2. It is noted that the target estimated path PA2 corresponds to a movement path of the target.

The target area calculation unit 242 calculates target presence areas EA2 indicating areas in which the target is present at given time intervals on the target estimated path PA2 on the X-Y plane of the two-dimensional coordinate system defined with reference to the actual own vehicle location. The target presence areas EA2 indicate presence areas of the target at given time intervals in a case in which the target travels along the target estimated path PA2.

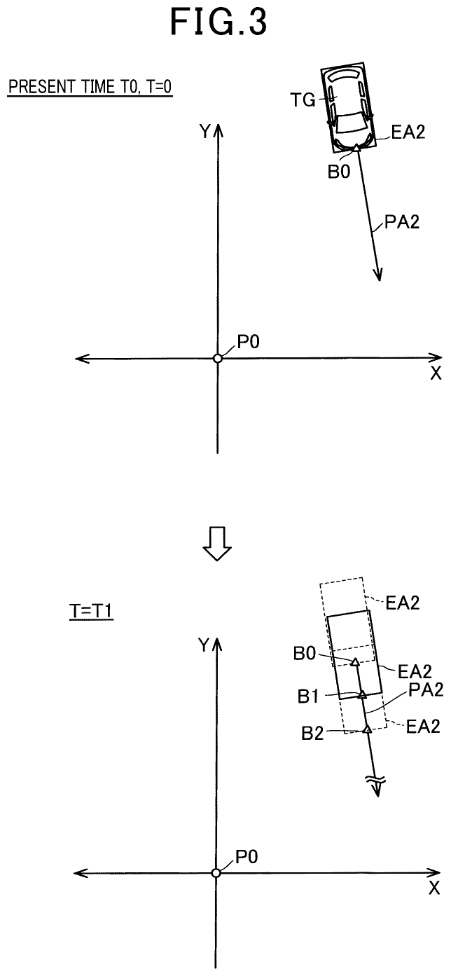

The upper part in FIG. 3 illustrates the target presence area EA2 calculated for the target TG at present time T0. The target presence area EA2 on the X-Y plane at present time T0 indicates a presence area of the target TG detected by the target detection device 110 at the actual own vehicle location. It is noted that, in the present embodiment, as an example of the target TG, another vehicle is illustrated. The target area calculation unit 242 sets the target presence area EA2 as a rectangular area including the whole outer periphery of the target TG viewed from above. For example, the rectangular area forming the target presence area EA2 is set according to the size of the target calculated by the target detection device 110.

In the lower part in FIG. 3 a future target presence area EA2 at the time at which the elapsed time T has elapsed by only T1 from the present T0 is illustrated with respect to the target presence area EA2 at the present T0 illustrated in the upper part in FIG. 3, as a comparison. For example, the target area calculation unit 242 calculates a passing position after only the elapsed time Tn has elapsed from the reference position P0 of the target TG at the present T0 on the target estimated path PA2, according to the target estimated path PA2 and a relative speed of the target with reference to the own vehicle. Then, rectangular areas whose reference positions Bn are set to the respective passing positions are calculated as the future target presence areas EA2 at the time at which the elapsed time T has elapsed by only the elapsed time Tn from the present T0.

The target information calculation unit 243 calculates a target solid D2, which is a solid indicating a movement of the target presence area EA2, by interpolating the plurality of target presence areas EA2 in the three-dimensional coordinate system defined with reference to the own vehicle location at the present T0. In the three-dimensional coordinate system, the target solid D2 illustrated in FIG. 4 indicates a movement of the target presence area EA2 with the elapsed time T. In the present embodiment, the target information calculation unit 243 converts the calculated plurality of target presence areas EA2 to information in the three-dimensional coordinate system. Then, in the three-dimensional coordinate system, linear interpolation is performed between four corners of the target presence areas EA2 adjacent to each other in the direction in which the T axis defining elapsed time extends, to calculate the target solid D2.

The collision determination unit 250 determines presence or absence of a possibility of a collision of the target with the own vehicle based on presence or absence of intersection between the own vehicle solid D1 and the target solid D2. In the present embodiment, the collision determination unit 250 calculates a first determination area DA1, which indicates the own vehicle presence area EA1 at the set elapsed time T, using the own vehicle solid D1. In addition, the collision determination unit 250 calculates a second determination area DA2, which indicates the target presence area EA2 at the same elapsed time T as that of the first determination area DA1, using the target solid D2. Then, if there is an overlapping area CPA between the calculated first determination area DA1 and second determination area DA2 at the same elapsed time T, the collision determination unit 250 determines that the own vehicle solid D1 and the target solid D2 intersect with each other.

As illustrated in FIG. 5, when the own vehicle solid D1 and the target solid D2 intersect with each other, there is an area CPA overlapping with the first determination area DA1 and the second determination area DA2 on the X-Y plane at the same elapsed time Ta. Hence, if there is the area CPA overlapping with the first determination area DA1 and the second determination area DA2 at the same elapsed time T, the collision determination unit 250 determines that the own vehicle and the target would collide with each other.

In contrast, when the own vehicle solid D1 and the target solid D2 do not intersect with each other, there is no area CPA overlapping with the first determination area DA1 and the second determination area DA2 on the X-Y plane at all elapsed times T. Hence, if there is no area CPA overlapping with the first determination area DA1 and the second determination area DA2 at the same elapsed time T, the collision determination unit 250 determines that the own vehicle and the target would not collide with each other.

In the present embodiment, the collision determination unit 250 calculates the first determination area DA1 and the second determination area DA2 at the same elapsed time T at predetermined elapsed time intervals ΔT between the present T0 and the estimated termination time TN. Then, the collision determination unit 250 uses the calculated first determination area DA1 and second determination area DA2 at the same elapsed time T to determine presence or absence of the overlapping area CPA.

### a-2. Collision Determination Process:

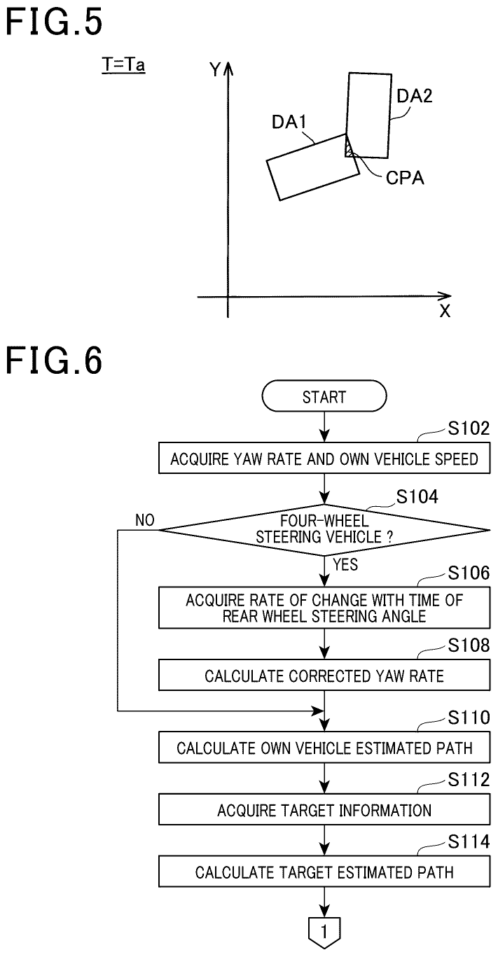

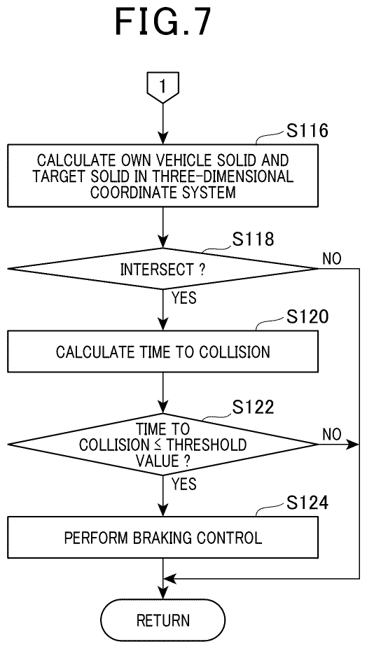

The collision determination device 200 performs a collision determination process illustrated in FIG. 6 and FIG. 7 to achieve the above collision determination. After the collision determination device 200 is instructed to perform the collision determination process, the process is continuously and repeatedly performed until the collision determination device 200 is instructed to terminate the process.

In step S102, the acquisition unit 212 acquires a yaw rate from the yaw rate sensor 120 and acquires an own vehicle speed from the wheel speed sensor 130.

In step S104, the own vehicle path estimation unit 213 determines whether the own vehicle is a four-wheel steering vehicle. The own vehicle path estimation unit 213 performs the determination according to, for example, the previously set type of the own vehicle. It is noted that if it has been previously determined that the path estimation device 210 is installed in a four-wheel steering vehicle, the own vehicle path estimation unit 213 may not perform step S104 and may perform step S106 described later following step S102.

If it is determined that the vehicle to be determined is a four-wheel steering vehicle (step S104: Yes), in step S106, the own vehicle path estimation unit 213 acquires the rate of change with time of the rear wheel steering angle. In step S108, the own vehicle path estimation unit 213 calculates a corrected yaw rate.

In step S110, the own vehicle path estimation unit 213 uses the corrected yaw rate and the own vehicle speed to calculate the own vehicle estimated path PA1. More specifically, the own vehicle path estimation unit 213 uses the corrected yaw rate and the own vehicle speed to calculate an estimated curve radius of the own vehicle VM and calculates the own vehicle estimated path PA1 based on the calculated estimated curve radius.

In step S104, if it is determined that the vehicle to be determined is not a four-wheel steering vehicle (step A104: No), step S106 and step S108 described above are not performed, and step S110 described above is performed. That is, if the vehicle to be determined is not a four-wheel steering vehicle, the own vehicle path estimation unit 213 uses the uncorrected yaw rate and the own vehicle speed to calculate the own vehicle estimated path PA1.

In step S112, the target path estimation unit 241 acquires target information from the target detection device 110. In step S114, the target path estimation unit 241 uses the target information to calculate the target estimated path PA2. It is noted that step S112 and step S114 may not be performed after step S102 to step S110 described above but be performed in parallel with step S102 to step S110.

In step S116 illustrated in FIG. 7, the own vehicle information calculation unit 232 calculates the own vehicle solid D1 indicating a movement of the own vehicle presence area EA1 on the own vehicle estimated path PA1 from the present T0 to the time at which a given time period has elapsed in the three-dimensional coordinate system defined with reference to the actual location of the own vehicle (refer to FIG. 2 and FIG. 4). In addition, in the present step, the target information calculation unit 243 calculates the target solid D2 indicating a movement of the target presence area EA2 on the target estimated path PA2 in the above three-dimensional coordinate system (refer to FIG. 3 and FIG. 4). It is noted that, as a specific procedure for calculating the own vehicle solid D1 and the target solid D2, for example, the procedure described in JP-A-2020-8288 may be used.

In step S118, the collision determination unit 250 determines whether the own vehicle solid D1 and the target solid D2 intersect with each other in the three-dimensional coordinate system. Specifically, as described with reference to FIG. 5, if there is the overlapping area CPA overlapping with the first determination area DA1 and the second determination area DA2 at the same elapsed time T, the collision determination unit 250 determines that the own vehicle solid D1 and the target solid D2 intersect with each other. If it is determined that the own vehicle solid D1 and the target solid D2 do not intersect with each other (step S118: No), step S102 described above is performed again.

If it is determined that the own vehicle solid D1 and the target solid D2 intersect with each other (step S118: Yes), in step S120, the collision determination unit 250 calculates a time to collision. The time to collision means a time period until the own vehicle and the target collide with each other at the actual own vehicle location. For example, the collision determination unit 250 calculates the time to collision by dividing a direct distance from the actual own vehicle location to the target by a relative speed of the target with respect to the own vehicle.

In step S122, the collision determination unit 250 determines whether the calculated time to collision is a predetermined threshold value or shorter. If it is determined that the time to collision is not the threshold value or shorter (step S122: No), in other words, if the time to collision is longer than the threshold value, braking control is not performed, and step S102 described above is performed again. The determination result that the own vehicle and the target would collide with each other is merely an estimation result based on the actual own vehicle location. If the time to collision is longer than the threshold value, the collision may be avoided due to future travel of the own vehicle. Hence, if the time to collision is longer than the threshold value, the braking control described later is not performed, and the process returns to step S102, whereby smooth travel of the own vehicle VM is suppressed from being interrupted.

If it is determined that the time to collision is the threshold value or shorter (step S122: Yes), in step S124, the collision suppression device 300 performs braking control. It is noted that, in this case, in addition to the braking control, an alarm may be issued by an alarm device, not shown. Thereafter, step S102 described above is performed again. The collision determination device 200 repeatedly performs the collision determination described above, and terminates the collision determination process when being instructed to terminate the process.

According to the path estimation device 210 of the embodiment described above, when the own vehicle is a four-wheel steering vehicle, since the own vehicle estimated path PA1 is estimated utilizing a corrected yaw rate, influence of the yaw rate of a rotation of the own vehicle VM in the uncorrected yaw rate can be suppressed, whereby accuracy in estimating the own vehicle estimated path PA1 can be suppressed from lowering.

In addition, since receiving a control signal indicating a rear wheel steering angle as rear wheel steering information, a vehicle to be determined is not required to include a rear wheel steering angle sensor for acquiring the rear wheel steering angle, whereby path estimation can be performed even for a vehicle that does not include a rear wheel steering angle sensor.

In addition, the collision determination device 200 including the path estimation device 210 of the present embodiment performs collision determination based on the own vehicle estimated path PA1 calculated using a corrected yaw rate. Hence, in a four-wheel steering vehicle, compared with the embodiment performing collision determination based on the estimated path calculated using an uncorrected yaw rate, an error between the own vehicle estimated path PA1 and an actual travel path of the own vehicle VM can be suppressed, and appropriate collision determination can be performed.

### B. Other Embodiments

(B1) In the above embodiment, the acquisition unit 212 acquires, as an uncorrected yaw rate, a yaw rate calculated using a yaw rate signal output from the yaw rate sensor 120. However, the present disclosure is not limited to this. For example, the acquisition unit 212 may acquire a yaw rate calculated using a steering angle signal output from a front wheel steering angle sensor or a yaw rate calculated using a lateral acceleration signal output from a lateral acceleration sensor. Also according to this embodiment, effects similar to those of the above embodiment are provided.

(B2) In the above embodiment, the own vehicle path estimation unit 213 calculates a corrected yaw rate and uses the corrected yaw rate to calculate the own vehicle estimated path PA1. However, the present disclosure is not limited to this. For example, the own vehicle path estimation unit 213 may calculate a corrected curve radius by adding a correction value determined depending on the rate of change with time of the rear wheel steering angle to an estimated curve radius calculated using the corrected yaw rate, and may calculate the own vehicle estimated path PA1 using the corrected curve radius. Also according to this embodiment, since the own vehicle estimated path PA1 is calculated using the rate of change with time of the rear wheel steering angle, influence of the yaw rate of a rotation of the own vehicle in the uncorrected yaw rate can be suppressed, whereby accuracy in estimating the own vehicle estimated path PA1 can be suppressed from lowering.

(B3) In the above embodiment, the path estimation device 210 is included in the collision determination device 200 as a device provided separately from the CPU 220. However, the present disclosure is not limited to this. The acquisition unit 212 and the own vehicle path estimation unit 213, which are function parts realized by the path estimation device 210, may be realized by the CPU 220. Also according to this embodiment, effects similar to those of the above embodiment are provided. In addition, the path estimation device 210 may not be provided in the collision determination device 200 or may be provided independently from the collision determination device 200.

(B4) In the above embodiment, the path estimation device 210 is installed in the collision determination device 200 and performs path prediction for collision determination. However, the present disclosure is not limited to this. The path estimation device 210 may perform not only path prediction for collision determination but also various sorts of path prediction for vehicle control. For example, the own vehicle path estimation unit 213 may be included in a location estimation device that estimates an actual location of the vehicle configured as a four-wheel steering vehicle and may perform path estimation for estimating the amount of travel from a past time point using a history of the yaw rate. Also according to this embodiment, using the corrected yaw rate can suppress accuracy in estimating the amount of travel from a past certain time point from lowering, compared with the embodiment using the uncorrected yaw rate in the four-wheel steering vehicle.

(B5) In the above embodiment, the path estimation device 210 is included in the collision determination device 200 installed in a vehicle and performs path estimation for the vehicle in which the path estimation device 210 is installed. However, the present disclosure is not limited to this. The path estimation device 210 may be installed not only in a vehicle in which the path estimation device 210 is installed but also in a control system performing overall control of a plurality of vehicles to perform path estimation for each of the plurality of vehicles. Also according to this embodiment, effects similar to those of the above embodiment are provided.

(B6) In the above embodiment, the target detection device 110 is a device configured by the millimeter-wave radar sensors 111 and the radar ECU 112. However, this is not a limitation. The target detection device 110 may be a device including an image sensor detecting a location of a target by using a captured image and a laser sensor detecting a location of a target by using laser light. In addition, when the own vehicle can perform inter-vehicle communication with another vehicle traveling around the own vehicle, the target detection device 110 may be a device by which the own vehicle acquires a location of a target detected by a target detection device included in the other vehicle through inter-vehicle communication. In addition, the target detection device 110 may be a device configured by combining these devices.

(B7) In the above embodiment, as a target, a vehicle is exemplified. However, this is not a limitation. The target may be any object that is likely to collide with the own vehicle, such as a vehicle, a bicycle, a motorcycle, a pedestrian, an animal, and a structure.

(B8) In the above embodiment, the target presence area EA2 of the target is set as a rectangular area including the whole outer periphery of the target viewed from above. However, this is not a limitation. The target presence area EA2 may be any polygon set so as to include the whole outer periphery of the target.

(B9) In the above embodiment, the collision determination unit 250 determines presence or absence of a possibility of a collision based on presence or absence of intersection between the own vehicle solid D1 and the target solid D2 extending in the three-dimensional coordinate system. However, this is not a limitation. The presence or absence of a possibility of a collision may be determined based on presence or absence of intersection between the linear own vehicle estimated path PA1 of the own vehicle and the linear target estimated path PA2 of the target in the two-dimensional coordinate system. Also according to this embodiment, presence or absence of a possibility a collision can be determined.

The path estimation device 210 and the processing thereof described in the present disclosure may be implemented by a dedicated computer which is provided by configuring a processor and a memory that are programmed to execute one or more functions embodied by a computer program. Alternatively, the path estimation device 210 and the processing thereof described in the present disclosure may be implemented by a dedicated computer which is provided by configuring a processor with one or more dedicated hardware logic circuits. Alternatively, the path estimation device 210 and the processing thereof described in the present disclosure may be implemented by one or more dedicated computers which are configured by combining a processor and a memory that are programmed to execute one or more functions, with a processor that is configured by one or more hardware logic circuits. Furthermore, the computer program may be stored in a computer readable non-transitory tangible storage medium, as instructions to be executed by a computer.

The present disclosure is not limited to the above-described embodiments and can be implemented with various configurations within a scope not deviating from the gist of the present disclosure. For example, technical features in the embodiments can be appropriately replaced or combined with each other in order to solve all or part of the problems described above or to achieve all or part of the effects described above. Some of the technical features can be appropriately deleted if they are not described as essentials herein.

An aspect of the present disclosure provides a path estimation device (210) that estimates a travel path (PA1) of a vehicle (VM) configured as a four-wheel steering vehicle. The path estimation device includes: an acquisition unit (212) that acquires rear wheel steering information, which is information concerning a steering angle of a rear wheel of the vehicle; and an own vehicle path estimation unit (213) that estimates the travel path by using a rate of change with time of the steering angle of the rear wheel specified using the rear wheel steering information.

According to the above path estimation device, since a rate of change with time of a steering angle of a rear wheel included in a vehicle configured as a four-wheel steering vehicle is used to estimate a travel path, influence of the rate of change with time of the steering angle of the rear wheel, that is, a yaw rate of a rotation, can be suppressed in path estimation, whereby accuracy in estimating a travel path can be suppressed from lowering.

The present disclosure can be implemented as the following aspects.

### (Aspect 1)

A path estimation device (210) configured to estimate a travel path (PA1) of a vehicle (VM) configured as a four-wheel steering vehicle, the path estimation device including:
an acquisition unit (212) configured to acquire rear wheel steering information, which is information concerning a steering angle of a rear wheel of the vehicle; and
an own vehicle path estimation unit (213) configured to estimate the travel path by using a rate of change with time of the steering angle of the rear wheel specified using the rear wheel steering information.

### (Aspect 2)

The path estimation device according to aspect 1, wherein
the own vehicle path estimation unit is configured to perform:
calculating a corrected yaw rate that is obtained by correcting a yaw rate, which is specified using a detection value of a sensor (120) included in the vehicle, with the rate of change with time of the steering angle of the rear wheel; and
estimating the travel path using the corrected yaw rate.

### (Aspect 3)

The path estimation device according to aspect 1 or aspect 2, wherein
the acquisition unit is configured to acquire a control signal for an instruction for the steering angle as the rear wheel steering information.

### (Aspect 4)

A collision determination device (200) configured to determine presence or absence of a possibility of a collision between a target (TG) located around a vehicle detected by a target detection device (110) and the vehicle, the collision determination device including:
the path estimation device according to any one of aspects 1 to 3; and
an own vehicle information calculation unit configured to calculate an own vehicle solid (D1), which is a solid indicating a movement of an own vehicle presence area (EA1) at predetermined time intervals on the estimated travel path in a three-dimensional coordinate system defined by a distance from an actual location along a traveling direction of the vehicle, a distance along a vehicle width direction of the vehicle, and elapsed time from the present;
a target path estimation unit (241) configured to estimate a movement path (PA2) of the target in the three-dimensional coordinate system based on a location of the target detected by the target detection device; and
a collision determination unit (250) configured to determine presence or absence of a possibility of a collision of the target with the vehicle based on presence or absence of intersection between the calculated own vehicle solid and the estimated travel path of the target.

What is claimed is:

1. A path estimation device configured to estimate a travel path of a vehicle configured as a four-wheel steering vehicle, the path estimation device comprising:
an acquisition configured to acquire rear wheel steering information, which is information concerning a steering angle of a rear wheel of the vehicle; and
an own vehicle path estimation unit configured to estimate the travel path by using a rate of change with time of the steering angle of the rear wheel specified using the rear wheel steering information.

2. The path estimation device according to claim 1, wherein the own vehicle path estimation unit is configured to perform:
calculating a corrected yaw rate that is obtained by correcting a yaw rate, which is specified using a detection value of a sensor included in the vehicle, with the rate of change with time of the steering angle of the rear wheel; and
estimating the travel path using the corrected yaw rate.

3. The path estimation device according to claim 1, wherein the acquisition unit is configured to acquire a control signal for an instruction for the steering angle as the rear wheel steering information.

4. A collision determination device configured to determine presence or absence of a possibility of a collision between a target located around a vehicle detected by a target detection device and the vehicle, the collision determination device comprising:
the path estimation device according to any one of claims 1 to 3; and
an own vehicle information calculation unit configured to calculate an own vehicle solid, which is a solid indicating a movement of an own vehicle presence area at predetermined time intervals on the estimated travel path in a three-dimensional coordinate system defined by a distance from an actual location along a traveling direction of the vehicle, a distance along a vehicle width direction of the vehicle, and elapsed time from the present;
a target path estimation unit configured to estimate a movement path of the target in the three-dimensional coordinate system based on a location of the target detected by the target detection device; and
a collision determination unit configured to determine presence or absence of a possibility of a collision of the target with the vehicle based on presence or absence of intersection between the calculated own vehicle solid and the estimated travel path of the target.
